(19) United States
(12) Patent Application Publication
(10) Pub. No.: US 2004/0267810 A1
(43) Pub. Date: Dec. 30, 2004

(54) Method, apparatus and system for efficient file indexing

(76) Inventors: Nelson F. Kidd, Camas, WA (US); Bryan Y. Roe, Camas, WA (US); Ylian Saint-Hilaire, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/607,723

(22) Filed: Jun. 27, 2003

(51) Int. Cl. G06F 17/00

(52) U.S. Cl. 707/104.1

(57) ABSTRACT

A method, apparatus and system for efficient file indexing are presented. In this regard, an index agent is introduced to receive an index file from a remote location in response to an event associated with a request, to parse the index file to extract entries, to select entries to store based at least in part upon both the spacing between the entries in the index file and an allocation of memory, and to store the selected entries into the memory.

### FIELD OF THE INVENTION

Embodiments of the present invention generally relate to the field of networking, and, more particularly to a method, apparatus and system for efficient file indexing.

### BACKGROUND

As consumer electronic devices get smaller and less expensive, manufacturers of such devices are forced to identify new ways to limit or lower their costs while still offering the features that consumers want.

One component common in consumer electronic devices is memory. Adding more memory devices to an electronic device would tend to increase its cost. Therefore, manufacturers would like to be able to use a limited amount of memory efficiently so as avoid the cost associated with increasing the amount of memory.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example network environment suitable for implementing the index agent, in accordance with one example embodiment of the invention;

FIG. 2 is a block diagram of an example index agent architecture, in accordance with one example embodiment of the invention;

FIGS. 3A, 3B, and 3C illustrate by way of example memory contents generated by the index agent, in accordance with one example embodiment of the invention;

FIG. 4 is a flow chart of an example method for processing an index, in accordance with one example embodiment of the invention; and

FIG. 5 is a flow chart of an example method for implementing an index agent, in accordance with one example embodiment of the invention.

### DETAILED DESCRIPTION

Embodiments of the present invention are generally directed to a method, apparatus and system for efficient file indexing. In this regard, in accordance with but one example implementation of the broader teachings of the present invention, an index agent is introduced. In accordance with but one example embodiment, the index agent employs an innovative method to efficiently utilize a fixed amount of memory to store index file entries. According to one example method, the index agent facilitates efficiency by dynamically changing, e.g., at run time, the density of stored entries of an arbitrarily large index file. This may reduce on average the amount of data that must be transferred to, for example, identify the location of a particular index entry, because there will be a limited range within which to search.

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

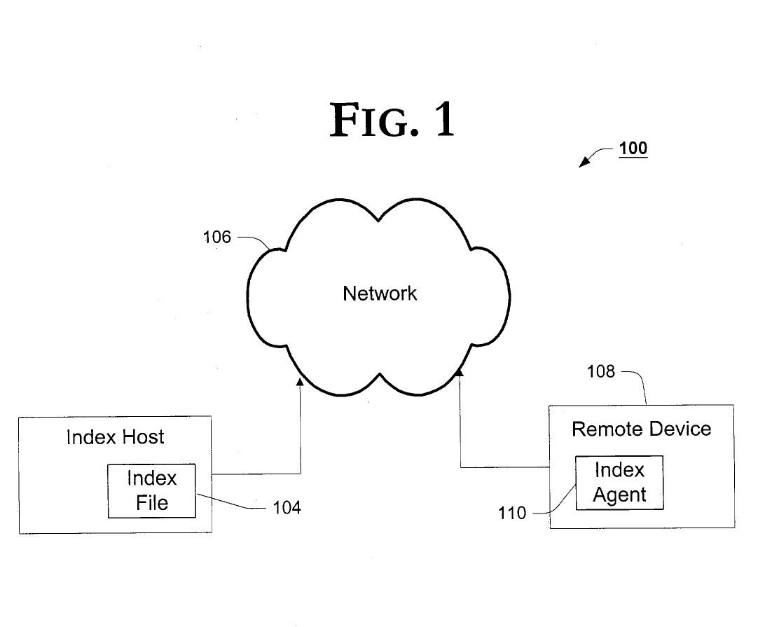

FIG. 1 is a block diagram of an example network environment suitable for implementing the index agent, in accordance with one example embodiment of the invention. In accordance with an example implementation, network environment 100 is intended to represent any of a number of network types including, but not limited to: wired, wireless, or any combination of wired and wireless data and/or communication networks employing any of a number of wired and/or wireless networking protocols. In accordance with the illustrated example embodiment, network environment 100 may include one or more of an index host 102, index file 104, network 106, remote device 108, and index agent 110 coupled as shown in FIG. 1. Index agent 110, as described more fully hereinafter, may well be used in electronic appliances of greater or lesser complexity than that depicted in FIG. 1. Also, the innovative selection attributes of index agent 110 as described more fully hereinafter may well be embodied in any combination of hardware and software.

Index host 102 may represent any type of electronic appliance or device that stores index file 104. In one embodiment, index host 102 is a Hyper Text Transfer Protocol (HTTP), or World Wide Web (Internet) server. In an alternate embodiment, index host 102 is a Universal Plug and Play (UPNP) Control Point, as defined by standards promulgated by the UPnP™ Forum (http://www.upnp.org).

Index file 104 may represent any type of electronic index file. In one embodiment, index file 104 represents an UPnP play list containing Universal Resource Indicators (URI's) which may identify network locations where electronic music files are stored.

Network 106 may represent any medium and/or protocol to communicatively couple index host 102 and remote device 108. In one embodiment, network 106 represents a Transmission Control Protocol Internet Protocol (TCP/IP) network, although the invention is not limited in this regard. In an alternate embodiment, network 106 represents a network within which a combination of multiple transmission protocols may be required including, but not limited to, the aforementioned TCP/IP protocol, Mobile IP protocol, General Purpose Radio System (GPRS) protocol, and the like.

Remote device 108 may represent any type of electronic appliance or device that can communicate with index host 102. In one embodiment, remote device 108 represents an UPnP Audio/Visual (AV) Media Renderer, which may be designed to play electronic music files. Such renderer may well be implemented within, or in cooperation with, a computing appliance. In an alternate implementation, remote device 108 is a wireless communication device in selective communication with index host 102.

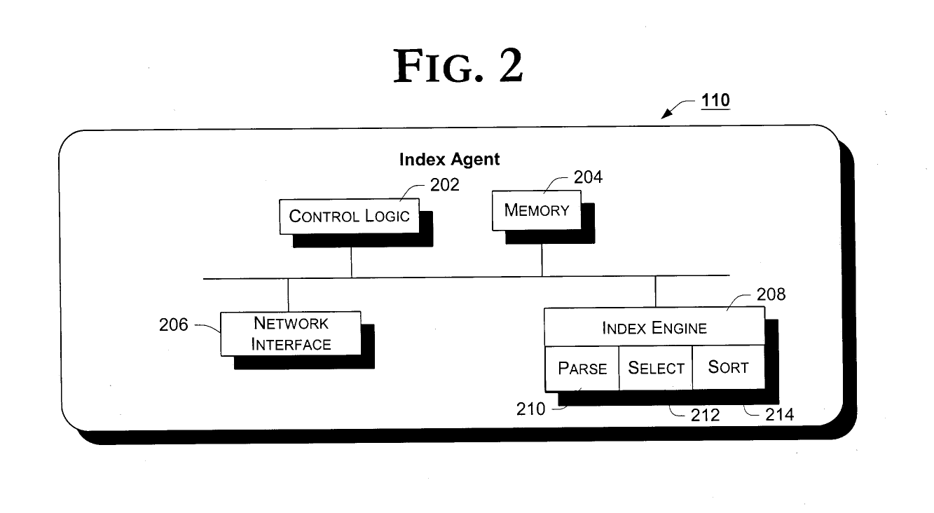

Index agent 110, as presented in greater detail with reference to FIG. 2, may receive and/or process index file(s) 104 in order to select and store index entries to facilitate efficient retrieval of information. In one embodiment, remote device 108 may utilize the stored index entries to play electronic music files from a play list in response to a user (not depicted) initiated command. In the case where index file 104 is larger than the amount of memory available within remote device 108 to store index file 104, index agent 110 may selectively determine which entries of index file 104 to store, and may do so in a manner so as to generally store index entries that are evenly distributed from within index file 104.

FIG. 2 is a block diagram of an example index agent architecture, in accordance with one example embodiment of the invention. As shown, index agent 110 may include one or more of control logic 202, memory 204, network interface 206, and index engine 208 coupled as shown in FIG. 2. In accordance with one aspect of the present invention, to be developed more fully below, index agent 110 may include an index engine 208 comprising one or more of parse services 210, select services 212, and/or sort services 214. It is to be appreciated that, although depicted as a number of disparate functional blocks, one or more of elements 202-214 may well be combined into one or more multi-functional blocks. Similarly, index engine 208 may well be practiced with fewer functional blocks, i.e., with only select services 212, without deviating from the spirit and scope of the present invention. In this regard, index agent 110 in general, and index engine 208 in particular, are merely illustrative of one example implementation of one aspect of the present invention. As used herein, index agent 110 may well be embodied in hardware, software, firmware and/or any combination thereof.

As introduced above, index agent 110 may selectively store index entries from index file 104. In one embodiment, the functionality of index agent 110 may be performed by software within remote device 108 or even within a different device, for example index host 102, which is able to affect remote device 108.

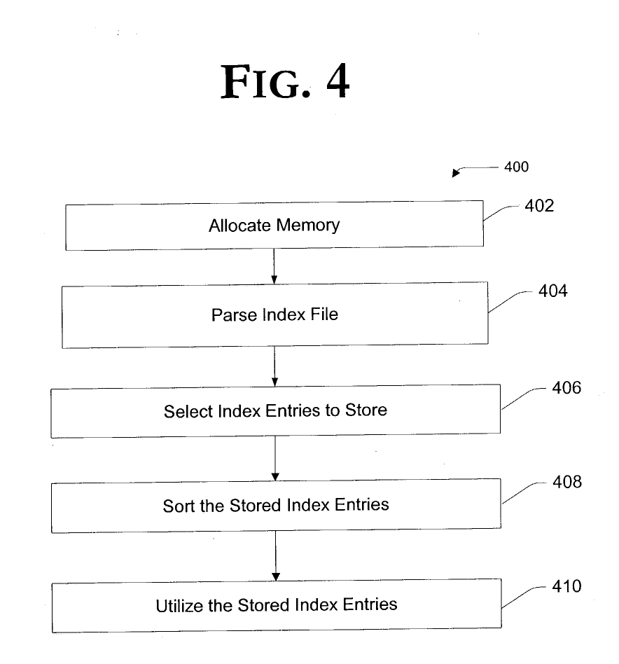

As used herein control logic 202 provides the logical interface between index agent 110 and remote device 108. In this regard, control logic 202 may manage one or more aspects of index agent 110 to provide a communication interface from remote device 108 to index entries resident thereon. According to one aspect of the present invention, though the claims are not so limited, control logic 202 receives initialization event indications such as, e.g., a request to retrieve an index file. Upon receiving such an indication, control logic 202 selectively invokes the resource(s) of index engine 208. As part of an example method for processing an index, as explained in greater detail with reference to FIG. 4, control logic 202 selectively invokes parse services 210 and select services 212 that extract and determine whether to store, respectively, index entries. Control logic 202 also selectively invokes sort services 214, as explained in greater detail with reference to FIG. 4, to sort the stored index entries. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In alternate implementations, control logic 202 is intended to represent content (e.g., software instructions, etc.), which when executed implements the features of control logic 202 described herein.

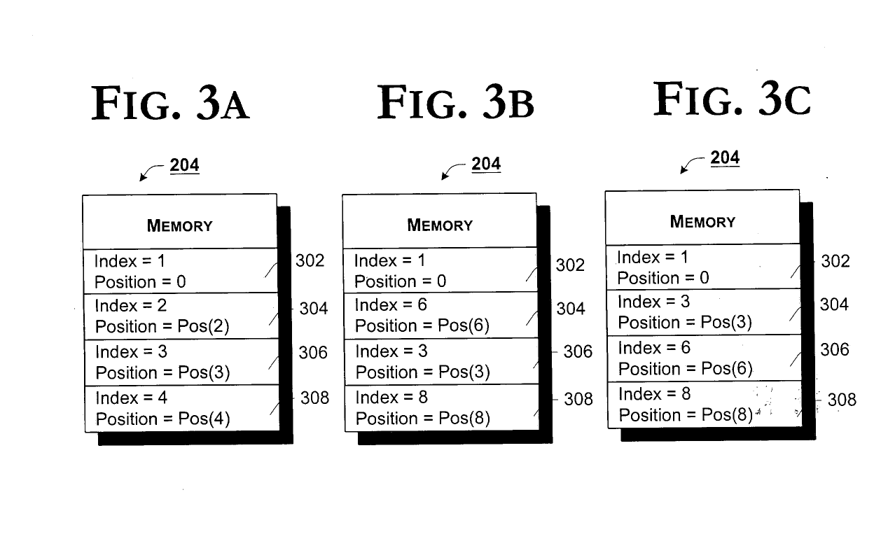

Memory 204 is intended to represent any of a wide variety of memory devices and/or systems known in the art. According to one example implementation, though the claims are not so limited, memory 204 may well include volatile and non-volatile memory elements, possibly random access memory (RAM) and/or read only memory (ROM). Graphical illustrations of example memory 204 contents are presented with reference to FIGS. 3A-3C.

Network interface 206 provides a path through which index agent 110 can communicate with index host 102 over network 106 to, for example, request and receive index file 104. Network interface 206 is intended to represent any of a wide variety of network interfaces and/or controllers known in the art. According to one example embodiment, though the claims are not so limited, network interface 206 represents a wireless network interface controller that complies with the Institute of Electrical and Electronics Engineers, Inc. (IEEE) 802.11b specification.

As introduced above, index engine 208 is selectively invoked by control logic 202 to extract index entries from index file 104, to selectively store extracted index entries, and to sort the stored index entries. In accordance with the illustrated example implementation of FIG. 2, index engine 208 is depicted comprising one or more of parse services 210, select services 212 and sort services 214. Although depicted as a number of disparate elements, those skilled in the art will appreciate that one or more elements 210-214 of index engine 208 may well be combined without deviating from the scope and spirit of the present invention.

Parse services 210, as introduced above, provide index agent 110 with the ability to extract index entries from index file 104. In one example embodiment, parse services 210 searches on predetermined boundaries within index file 104 to find the beginning and/or end of an index entry. In an alternate embodiment, parse services 210 looks for a particular string of characters that represent a beginning and/or end of a particular index entry.

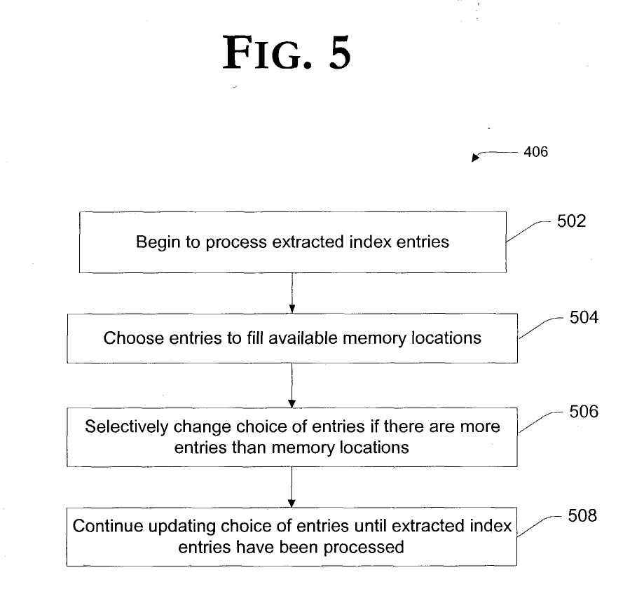

As introduced above, select services 212 provide index agent 110 with the ability to selectively store index entries extracted from index file 104 by parse services 210. Select services 212 may choose index entries to store based on any of a number of possible techniques. While one example technique is presented hereinafter with reference to FIG. 5, other techniques that do not deviate from the scope of this invention may occur to those skilled in the art.

Sort services 214, as introduced above, provide index agent 110 with the ability to sort the stored index entries. In one embodiment, sort services 214 sorts the stored entries based upon their memory address locations.

FIGS. 3A, 3B, and 3C illustrate by way of example memory contents generated by the index agent, in accordance with one example embodiment of the invention. In these examples, for ease of understanding, it is assumed memory 204 includes four memory locations (302-308) each capable of storing one index entry, and there are a total eight index entries extracted from index file 104. As used herein, index entries may include information such as memory addresses, or pointers to other memory address where information may be found, which are represented by a position value for each index entry.

FIG. 3A is intended to represent a first pass by select services 212 through the available memory 204. In one embodiment, select services 212 does not know beforehand the total number of index entries within index file 104, and thus stores extracted entries until memory 204 is full. In an alternate embodiment, if select services 212 “knew” the number of index entries within index file 104 beforehand, select services 212 could determine the appropriate spacing and choose the entries to store in a single pass.

FIG. 3B is intended to represent a second pass by select services 212 through the available memory 204. In one embodiment, select services 212 increases the spacing between entries chosen to be stored in proportion to the number of passes made through the available memory 204. In this simple example, because it was a second pass, select services 212 ignored every other entry after entry #4 (namely entries #5 and #7) and overwrote every other memory location (namely locations 304 and 308).

FIG. 3C represents the contents of memory 204 after sort services 214 has sorted the entries, in this case, from lowest to highest based on their position values, effectively swapping the entries stored in locations 304 and 306.

FIG. 4 is a flow chart of an example method for processing an index, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention. The method begins with an allocation (402) of memory 204 in index agent 110. In one embodiment, memory 204 is allocated in portions or locations each capable of storing a certain number of index entries.

Parse services 210 then parse (404) index file 104 to extract the index entries. In one embodiment, index agent 110 does not know beforehand the number of index entries within index file 104. In an alternate embodiment, index agent 110 does receive an indication of the number of index entries within index file 104 and utilizes this information when parsing and selecting entries to store.

Next, select services 212 is executed (406) as presented in greater detail with reference to FIG. 5 to select index entries to store in memory 204.

Sort services 214 then sort (408) the stored index entries. In one embodiment, the sorting takes place only after the selection step (406) is completed. In an alternate embodiment, the sorting takes place during the selection step (406).

Finally, the stored index entries are utilized (410) by remote device 108. In one embodiment, remote device 108 may issue an HTTP-RANGE command and index host 102 may respond with an HTTP-206 partial content return status. For example, if the contents of memory 204 were as shown in FIG. 3C, and remote device 108 needed to find the position of index 2, remote device 108 might be able to search in the range between the positions of index entries 1 and 3 (which were stored in locations 302 and 304, respectively).

FIG. 5 is a flow chart of an example method for implementing an index agent, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention. The example method presented begins with select services 212 beginning to process (502) extracted index entries. In one embodiment, processing involves counting the extracted index entries. Select services 212 may maintain one of more counters to keep track of, for example, total entries extracted, entries stored, memory locations available, a current offset, a value by which to increment the offset, a number of entries to skip and/or passes through available memory.

Next, select services 212 chooses (504) entries to fill available memory locations. In one embodiment, where select services 212 “knows” beforehand the number of index entries within index file 104, the choice may be based on a calculated spacing between index entries. In an alternate embodiment, where select services 212 does not “know” beforehand the number of index entries within index file 104, all extracted entries may be chosen until there are no more available memory locations, as in, for example FIG. 3A.

Where there are more extracted index entries than available memory locations, select services 212 may then change (506) choices by overwriting stored index entries previously chosen. In one embodiment, select services 212 may skip over a number of extracted entries (not choosing to store them) in proportion to the number of passes already made through the memory locations, as in, for example FIG. 3B.

Select services 212 then continues updating (508) the choices made until the extracted index entries have been, at least substantially, processed. In one embodiment, select services 212 may increment counters and/or variables to keep track of, for example, total entries extracted, entries stored, memory locations available, a current offset, a value by which to increment the offset, a number of entries to skip and/or passes through available memory. Select services 212 may then perform compares or other logical or arithmetic functions to determine which entries to store until all entries have been considered.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A method comprising:
parsing a received index file to extract one or more entries; and
selecting at least a subset of the extracted entries to store based at least in part upon both a spacing between the entries in the index file and an amount of memory available for allocation.

2. The method of claim 1, wherein parsing a received index file comprises:
parsing a play list received through Universal Plug and Play (UPnP) networked communication.

3. The method of claim 2, further comprising sorting the stored entries.

4. The method of claim 2, wherein parsing the play list to extract entries comprises:
parsing the play list to extract Universal Resource Indicators (URI's).

5. The method of claim 4, further comprising issuing a Hyper Text Transfer Protocol (HTTP)-RANGE command to retrieve an URI not stored in the memory.

6. The method of claim 1, wherein selecting at least a subset of the extracted entries to store further comprises:
selecting at least a subset of the extracted entries to store without a priori knowledge as to a number of entries within the index file.

7. An electronic appliance, comprising:
a network interface to receive an index file; and
an index engine coupled with the network interface, the index engine to parse the index file for entries and to select entries to store based at least in part upon both the spacing between the entries in the index file and an amount of memory available for allocation.

8. The electronic appliance of claim 7, wherein the electronic appliance comprises a Universal Plug and Play (UPNP) Audio/Visual (AV) MediaRenderer.

9. The electronic appliance of claim 8, wherein the index file comprises a play list containing Universal Resource Indicators (URI's).

10. The electronic appliance of claim 9, further comprising the index engine to sort the stored entries.

11. The electronic appliance of claim 10, further comprising the index engine to issue a Hyper Text Transfer Protocol (HTTP)-RANGE command to retrieve an URI not stored in the memory.

12. The electronic appliance of claim 7, wherein the index engine to select entries to store further comprises the index engine to select entries to store without a prior knowledge as to a number of entries within the index file.

13. A storage medium comprising content which, when executed by an accessing machine, causes the machine to implement an index agent in the accessing machine, the index agent to receive an index file from a remote location in response to an event associated with a request, the index agent to parse the index file to extract entries, the index agent to select entries to store based at least in part upon both the spacing between the entries in the index file and an allocation of memory, and the index agent to store the selected entries into the memory.

14. The storage medium of claim 13, wherein the content to receive the index file comprises content which, when executed by the accessing machine, causes the accessing machine to receive a play list through Universal Plug and Play (UPnP) networked communication.

15. The storage medium of claim 14, wherein the content to parse the play list to extract entries comprises content which, when executed by the accessing machine, causes the accessing machine to parse the play list to extract Universal Resource Indicators (URI's).

16. The storage medium of claim 15, further comprising content which, when executed by the accessing machine, causes the accessing machine to sort the stored entries.

17. The storage medium of claim 16, further comprising content which, when executed by the accessing machine, causes the accessing machine to issue a Hyper Text Transfer Protocol (HTTP)-RANGE command to retrieve an URI not stored in the memory.

18. The storage medium of claim 13, wherein the content to select entries to store further comprises content which, when executed by the accessing machine, causes the accessing machine to select entries to store without a priori knowledge as to a number of entries within the index file.
